(19) United States
(12) Patent Application Publication
(10) Pub. No.: US 2012/0242140 A1
(43) Pub. Date: Sep. 27, 2012

(54) PUMP DEVICE

(75) Inventors: Toshihiro KOIZUMI, Atsugi-shi (JP); Chiharu Nakazawa, Kawasaki-shi (JP); Masaki Misunou, Atsugi-shi (JP)

(73) Assignee: HITACHI AUTOMOTIVE SYSTEMS, LTD.

(21) Appl. No.: 13/248,410

(22) Filed: Sep. 29, 2011

(30) Foreign Application Priority Data
Mar. 24, 2011 (JP) 2011-065614

(51) Int. Cl. B60T 13/16; F01C 19/08; F01C 19/00

(52) U.S. Cl. 303/10; 418/140; 418/131

(57) ABSTRACT

A pump device comprising a first side plate arranged at one axial side of a drive gear and having a first contact surface contacting to a first side surface of the drive gear, a friction coefficient of the first contact surface being smaller than that of the first side surface of the drive gear, a second side plate arranged at the other axial side of the drive gear and having a second contact surface contacting to a second side surface of the drive gear, a friction coefficient of the second contact surface being smaller than that of the second side surface of the drive gear and a seal member incorporated with the first and second side plates to constitute a pump chamber, the seal member sealing tops of teeth of the drive gear and having a friction coefficient that is smaller than that of the tops of the teeth.

### BACKGROUND OF THE INVENTION

1. Field of the Invention

The present invention relates to pump devices of hydraulic brakes and more particularly to pump devices of a type that is employed in a brake fluid pressure control system.

2. Description of the Related Art

One of the pump devices of the above-mentioned type is shown in Japanese Laid-open Patent Application (tokkai) 2006-125272.

The pump device shown in the publication comprises a gear (viz., inner rotor) one side surface of which is oiltightly sealed by a mechanical seal member and the other side surface of which is oiltightly sealed by a plastic seal member.

### SUMMARY OF THE INVENTION

However, due to the nature of the mechanical seal member employed, the sliding resistance applied to the gear (or inner rotor) from the mechanical seal member under rotation of the gear is not small, and thus, smoothed rotation of the gear is not obtained, which induces increase in friction torque of the pump device. As is easily understood, increase of such friction torque makes the pumping operation of the pump device poor.

It is therefore an object of the present invention to provide a pump device which is free of the above-mentioned drawback.

According to the present invention, there is provided a pump device that employs an improved arrangement in which metal-made gears of the pump device are each slidably and oiltightly held or put between resin-made members or portions, the friction coefficient of the resin being smaller than that of the metal.

According to the present invention, there are provided both a tandem type external gear pump and a trochoid type pump which are constructed to practically employ the above-mentioned improved arrangement.

In accordance with a first aspect of the present invention, there is provided a pump device which comprises a drive gear driven by a drive shaft; a first side plate arranged at an axial side of the drive gear and having a first contact surface that is in contact with a first side surface of the drive gear, a friction coefficient of the first contact surface being smaller than that of the first side surface of the drive gear; a second side plate arranged at the other axial side of the drive gear and having a second contact surface that is in contact with a second side surface of the drive gear, a friction coefficient of the second contact surface being smaller than that of the second side surface of the drive gear; and a seal member incorporated with the first and second side plates to constitute a pump chamber to pump an operation fluid from an inlet to an outlet, the seal member functioning to seal tops of teeth of the drive gear and having a friction coefficient that is smaller than that of the tops of the teeth.

In accordance with a second aspect of the present invention, there is provided a pump device which comprises a drive gear driven by a drive shaft; a driven gear meshed with the drive gear to rotate; a first side plate arranged at one side of the drive and driven gears and having a first contact surface that is in contact with first side surfaces of the drive and driven gears, a friction coefficient of the first contact surface being smaller than that of the first side surfaces of the drive and driven gears; a second side plate arranged at the other side of the drive and driven gears and having a second contact surface that is in contact with second side surfaces of the drive and driven gears, a friction coefficient of the second contact surface being smaller than that of the second side surfaces of the drive and driven gears; and a seal member incorporated with the first and second side plates to constitute a pump chamber to pump an operation fluid from an inlet to an outlet, the seal member functioning to seal tops of teeth of the drive and driven gears and having a friction coefficient that is smaller than that of the tops of the teeth.

In accordance with a third aspect of the present invention, there is provided a pump device for use in a brake fluid pressure control system, which comprises a first drive gear driven by a drive shaft; a first driven gear meshed with the first drive gear to rotate; a first side plate arranged at one side of the pump device and having a first contact surface that is in contact with first side surfaces of the first drive and driven gears, a friction coefficient of the first contact surface being smaller than that of the first side surfaces of the first drive and driven gears; a second drive gear driven by the drive shaft together with the first drive gear; a second driven gear meshed with the second drive gear to rotate; a second side plate arranged at the other side of the pump device and having a second contact surface that is in contact with second side surfaces of the second drive and driven gears, a friction coefficient of the second contact surface being smaller than that of the second side surfaces of the second drive and driven gears; a center plate arranged between a unit of the first drive and driven gears and another unit of the second drive and driven gears, the center plate having a third contact surface that is in contact with third side surfaces of the first drive and driven gears and a fourth contact surface that is in contact with fourth side surfaces of the second drive and driven gears, a friction coefficient of the third contact surface being smaller than that of the third side surfaces and a friction coefficient of the fourth contact surface being smaller than that of the second drive and driven gears; a first seal member incorporated with the first side plate and the center plate to constitute a first pump chamber to pump an operation fluid from an inlet to an outlet, the first seal member functioning to seal tops of first teeth of the first drive and driven gears and having a friction coefficient that is smaller than that of the tops of the firth teeth; and a second seal member incorporated with the second side plate and the center plate to constitute a second pump chamber to pump the operation fluid from another inlet to another outlet, the second seal member functioning to seal tops of second teeth of the second drive and driven gears and having a friction coefficient that is smaller than that of the tops of the second teeth, wherein upon brake operation by a driver, each of the first and second pump chambers takes in a brake fluid from a master cylinder and feeds the brake fluid to selected wheel cylinders of road wheels through selected pressure ON/OFF valves.

### BRIEF DESCRIPTION OF THE DRAWINGS

Other objects and advantages of the present invention will become apparent from the following description when taken in conjunction with the accompanying drawings, in which:

FIG. 1 is a schematic view of a brake fluid pressure control system to which a pump device of a first embodiment of the present invention is practically applied;

FIG. 2 is an axially sectioned view of the pump device of the first embodiment;

FIG. 3 is an axially sectioned view of the pump device of the first embodiment, but it is taken in a different angle;

FIG. 4 is a perspective view of a center plate employed in the pump device of the first embodiment;

FIG. 5 is a perspective view of a side plate employed in the pump device of the first embodiment;

FIG. 6 is a back view of the side plate employed in the pump device of the first embodiment;

FIG. 7 is a front view of the side plate employed in the pump device of the first embodiment;

FIG. 8 is a view similar to FIG. 6, but showing also a lower pressure zone illustrated by diagonal lines;

FIG. 9 a view similar to FIG. 7, but showing also a lower pressure zone illustrated by diagonal lines;

FIG. 10 is a graph depicting friction coefficients of four materials of the side plate with respect to PV value;

FIG. 11 is an illustration depicting the state of a transition of brake oil pressure that is affected by the width of an annular projection formed on a side plate in case of the first embodiment, the annular projection being in contact with a drive or driven gear;

FIG. 12 is a graph depicting a relation between a width of a top surface of annular projection formed on the side plate of the first embodiment and mechanical efficiency of pump device;

FIG. 13 is an axially sectioned view of a pump device of a second embodiment of the present invention;

FIG. 14 is an axially sectioned view of the pump device of the second embodiment of the present invention, but it is taken in a different angle;

FIG. 15 is a perspective view of a first side plate employed in the pump device of the second embodiment;

FIG. 16 is a perspective view of a second side plate employed in the pump device of the second embodiment;

FIG. 17 is a back view of the second side plate employed in the pump device of the second embodiment;

FIG. 18 is a front view of the second side plate employed in the pump device of the second embodiment;

FIG. 19 is a view similar to FIG. 17, but also showing a lower pressure zone illustrated by diagonal lines;

FIG. 20 is a view similar to FIG. 18, but also showing a lower pressure zone illustrated by diagonal lines; and

FIG. 21 is an axially sectioned view of a pump device of a third embodiment of the present invention.

### DETAILED DESCRIPTION OF THE INVENTION

In the following, three embodiments 1A, 1B and 1C of a pump device 1 of the present invention will be described in detail with reference to the accompanying drawings.

Before starting description on the three embodiments 1A, 1B and 1C, explanation will be directed to a brake fluid pressure control system 32 to which pump device 1 of the present invention is practically applied.

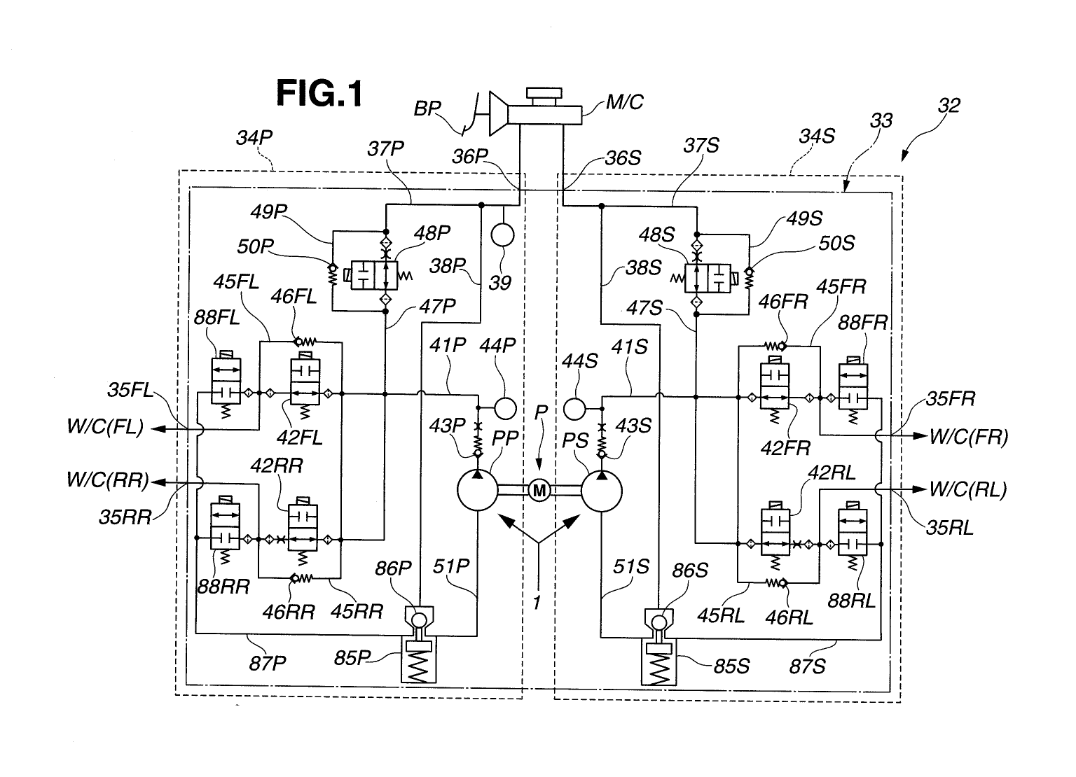

Referring to FIG. 1, there is schematically shown the brake fluid pressure control system 32 to which the pump device 1 of the invention is applied.

A pressure circuit is arranged in a pressure control unit 33 provided between a master cylinder M/C and each of wheel cylinders W/C.

Brake fluid pressure control system 32 is designed to carry out a hydraulic pressure control in accordance with a desired hydraulic pressure needed by a vehicle dynamics controller (viz., VDC) and an anti-lock brake system (viz., ABS).

As shown, brake fluid pressure control system 32 is arranged to have a so-called “X-piping” comprising P-type brake pressure circuit 34P and S-type brake pressure circuit 34S.

P-type brake pressure circuit 34P is connected to both a wheel cylinder W/C(FL) for a left-front road wheel and a wheel cylinder W/C(RR) for a right-rear road wheel and S-type brake pressure circuit 34S is connected to both a wheel cylinder W/C(FR) for a right-front road wheel and a wheel cylinder W/C(RL) for a left-rear road wheel.

Fluid pressure control system 32 is connected to each of the wheel cylinders W/C(FL), W/C(RR), W/C(FR) and W/C(RL) through a wheel cylinder port 35FL, 35RR, 35FR or 35RL, as shown.

Pump device 1 (viz., pump device 1A of the first embodiment) is of a tandem type that comprises a first external gear pump unit PP connected to P-type brake pressure circuit 34P and a second external gear pump unit PS connected to S-type brake pressure circuit 34S.

Master cylinder M/C and pressure control unit 33 are connected by liquid passages 37P and 37S through master cylinder ports 36P and 36S. Liquid passage 37P or 37S and an inlet side of pump device 1 are connected though a liquid passage 38P or 38S. A master cylinder pressure sensor 39 is connected to liquid passage 37P at a position between master cylinder port 36P and a junction part where liquid passage 37P and liquid passage 38P are connected.

An outlet side of pump device 1 and each wheel cylinder W/C are connected through a liquid passage 41P or 41S. In liquid passage 41P or 41S, there is mounted a so-called pressure ON/OFF valve 42FL, 42FR, 42RL or 42RR that is a normally open solenoid valve. In liquid passage 41P or 41S at a position between pressure ON/OFF valve 42FL, 42FR, 42RL or 42RR and pump device 1, there is arranged a check valve 43P or 43S, as shown.

Each check valve 43P or 43S is arranged to allow a flow of brake fluid in a direction from pump device 1 toward pressure ON/OFF valve 42FL, 42FR, 42RL or 42RR and block a flow of brake fluid in a reversed direction. In liquid passage 41P or 41S at a position between pressure ON/OFF valve 42FL, 42FR, 42RL or 42RR and pump device 1, there is arranged an outlet pressure sensor 44P or 44S, as shown.

To liquid passage 41P or 41S, there is connected a bypass passage 45FL, 45FR, 45RL or 45RR that bypasses pressure ON/OFF valve 42FL, 42FR, 42RL or 42RR. In each bypass passage 45FL, 45FR, 45RL or 45RR, there is arranged a check valve 46FL, 46FR, 46RL or 46RR, as shown.

Each check valve 46FL, 46FR, 46RL or 46RR is arranged to allow a flow of brake fluid in a direction from corresponding wheel cylinder W/C toward pump device 1, and block a flow of brake fluid in a reversed direction.

Master cylinder M/C and liquid passage 41P or 41S are connected through a liquid passage 47P or 47S. Liquid passage 41P or 41S and liquid passage 47P or 47S are connected at a position between pump device 1 and pressure ON/OFF valve 42FL, 42FR, 42RL or 42RR, as shown. In liquid passage 47P or 47S, there is arranged a gate out valve 48P or 48S that is a normally open solenoid valve.

To liquid passage 47P or 47S, there is connected a bypass passage 49P or 49S that bypasses gate out valve 48P or 48S. In liquid passage 49P or 49S, there is arranged a check valve 50P or 50S that allows a flow of brake fluid in a direction from master cylinder M/C toward wheel cylinder W/C and blocks a flow of brake fluid in a reversed direction.

To inlet side of pump device 1, there is connected a reservoir 85P or 85S, as shown. Reservoir 85P or 85S and pump device 1 are connected through a liquid passage 51P or 51S. Between reservoir 85P or 85S and pump device 1, there is arranged a check valve 86P or 86S.

While cylinder W/C and liquid passage 51P or 51S are connected through a liquid passage 87P or 87S, and liquid passage 87P or 87S and liquid passage 51P or 51S are jointed at a position between check valve 86P or 86S and reservoir 85P or 85S. In liquid passage 87P or 51S, there is arranged a pressure decreasing valve 88FL, 88FR, 88RL or 88RR that is a normally closed solenoid valve, as shown.

### First Embodiment

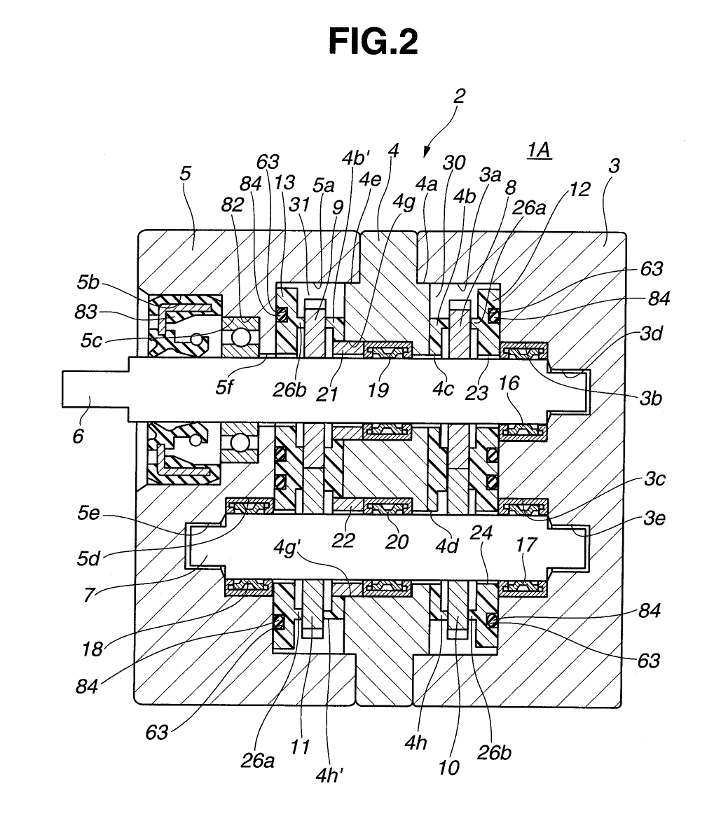

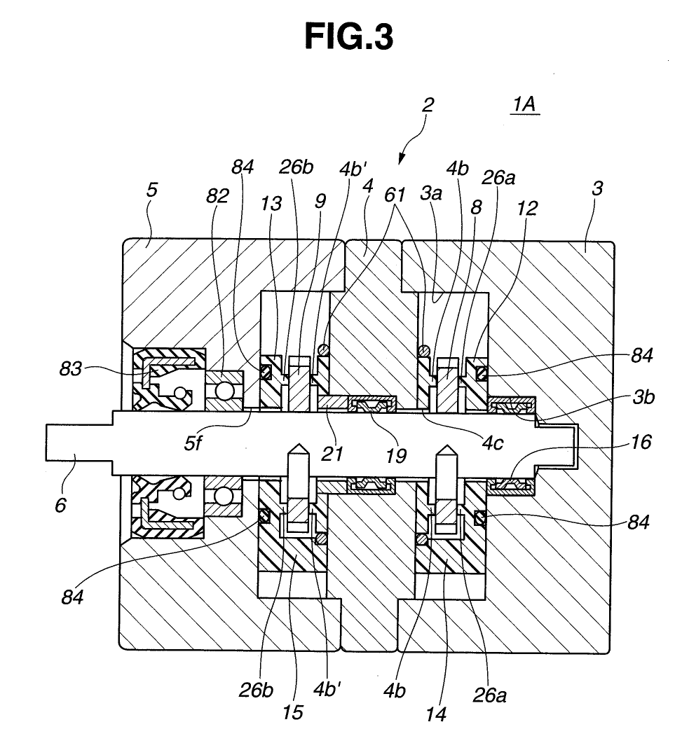

In the following, a pump device 1A of a first embodiment will be described in detail with the aid of FIGS. 2 and 3 that are axially sectioned views of pump device 1A.

Pump device 1A is a tandem gear pump that feeds wheel cylinders with compressed brake fluid by practically using pumping operation of after-mentioned first and second pump chambers 30 and 31.

As is seen from FIG. 2, pump device 1A has a pump case 2. Pump case 2 comprises a front case 3, a center plate 4 and a rear case 5.

In the following, for ease of description, an axial direction of the assembled pump device 1A that is directed to front case 3 will be referred to “axially plus side or direction” and another axial direction of the pump device 1A that is directed to rear case 5 will be referred to “axially minus side or direction”.

Within pump case 2, there is rotatably installed a drive shaft 6 that is driven by an electric motor (not shown). To drive shaft 6, there are tightly mounted first and second drive gears 8 and 9 that thus rotate together with drive shaft 6.

Within pump case 2, there is further rotatably installed a driven shaft 7 that is arranged in parallel with drive shaft 6, as shown. To driven shaft 7, there are tightly mounted first and second driven gears 10 and 11 that thus rotate together with driven shaft 7.

The gears 8, 9, 10 and 11 are constructed of a metal, such as steel or the like.

As shown, first drive gear 8 is engaged or meshed with first driven gear 10, and second drive gear 9 is engaged or meshed with second driven gear 11.

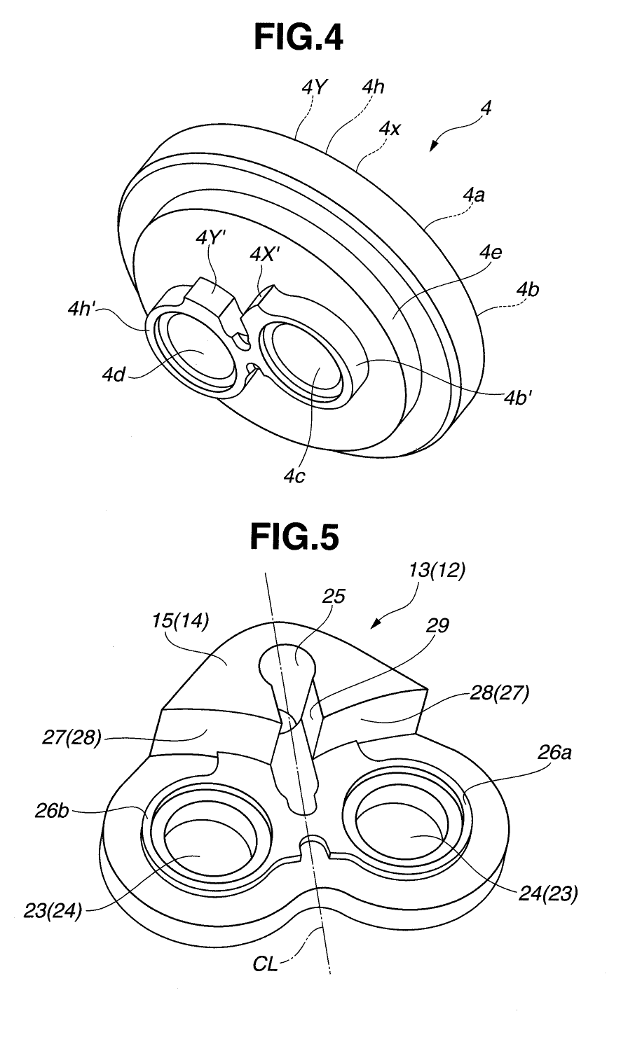

At an axially plus side of first drive and driven gears 8 and 10, there is arranged a first side plate 12 (see FIG. 5), and at an axially minus side of second drive and driven gears 9 and 11, there is arranged a second side plate 13 (see FIG. 5).

First and second side plates 12 and 13 are each constructed of an engineering plastic which is, for example, ABS (acrylonitrile butadiene styrene), PC (polycarbonates), PA (polyamides), PBT (polybutylene telephthalate), PET (polyethylene telephthalate), Polyimides, etc.

Center plate 4 is arranged at an axially minus side of first drive and driven gears 8 and 10, but at an axially plus side of second drive and driven gears 9 and 11, as shown.

As will be described in detail hereinafter, center plate 4 is constructed of a metal and provided at axially opposed sides thereof with resin-made portions.

Between center plate 4 and first side plate 12, there are sandwiched first drive and driven gears 8 and 10, and between center plate 4 and second drive and driven gears 9 and 11, there to are sandwiched second driven and driven gears 9 and 11, as shown.

As will be understood from FIG. 3, first side plate 12 is integrally formed with a seal block 14 for providing curved seal surfaces 27 and 28 that face toward through bores 23 and 24 respectively, and second side plate 13 is integrally formed with a seal block 15 for providing curved seal surfaces 27 and 28 that face toward through bores 23 and 24 respectively.

For the reasons as will be described hereinafter, to such curved seal surfaces 27 and 28, there are intimately attached curved seal surfaces 4X, 4Y, 4X′ and 4Y′ of center plate 4 for achieving an oiltight sealing therebetween.

Furthermore, under operation of pump device 1A, tops of teeth of drive and driven gears 8, 9, 10 and 11 slidably contact the curved seal surfaces 27 and 28 (or 28 and 27) for pumping the brake fluid.

More specifically, each of seal block 14 and seal block 15 (see FIG. 5) of side plates 12 and 13 is formed with curved seal surfaces 27 and 28 (or 28 and 27) to which curved seal surfaces 4X and 4Y (or 4Y′ and 4X′) provided by center plate 4 oiltightly contact, respectively.

In the following, construction of front case 3 will be described in detail with the aid of FIG. 2.

Front case 3 is made of a metal, and as is seen from FIG. 2, front case 3 is formed with a cup-shaped gear receiving recess 3a that is opened to an axially minus side. Within gear receiving recess 3a, there are installed first drive and driven gears 8 and 10, as shown.

From a bottom wall of gear receiving recess 3a, there extend two bearing receiving recesses 3b and 3c in an axially plus direction. Within bearing receiving recesses 3b and 3c, there are press-fitted respective needle bearings 16 and 17.

As shown, from bearing receiving recess 3b, there extends a drive shaft end receiving recess 3d in an axially plus direction, and from bearing receiving recess 3c, there extends a driven shaft end receiving recess 3e in an axially plus direction. Within the recesses 3d and 3e, there are rotatably received respective ends (viz., right ends in FIG. 2) of drive and driven shafts 6 and 7.

In the following, construction of rear case 5 will be described in detail with the aid of FIG. 2.

As is seen from FIG. 2, rear case 5 is also made of a metal and formed with a cap-shaped gear receiving recess 5a that is opened to an axially plus side. Within gear receiving recess 5a, there are installed second drive and driven gears 9 and 10, as shown.

From a bottom wall of gear receiving recess 5a, there extends a drive shaft passing bore 5f in an axially minus direction. At an axially minus end side of rear case 5, there is formed a seal member receiving recess 5b from which a bearing receiving recess 5c extends in an axially plus direction. These two recesses 5b and 5c are merged and concentric with drive shaft passing bore 5f.

Within bearing receiving recess 5c, there is press-fitted a ball bearing 82, and within seal member receiving recess 5b, there is operatively installed a seal member 83. As shown, an inner race of ball bearing 82 holds drive shaft 6 for smoothing rotation of drive shaft 6, and seal member 83 has lips that are in contact with a cylindrical outer surface of drive shaft 6 to achieve sealing therebetween.

As is seen from FIG. 2, from a bottom wall of gear receiving recess 5a, there further extends a bearing receiving recess 5d in an axially minus direction. Within bearing receiving recess 5d, there is press-fitted a needle bearing 18. From bearing receiving recess 5d, there extends a driven shaft end receiving recess 5e in an axially minus direction. Within recess 5e, there is rotatably to received an end (viz., left end in FIG. 2) of driven shaft 7.

In the following, construction of center plate 4 will be described in detail with the aid of FIGS. 2, 3 and 4.

As is seen from FIG. 4, center plate 4 is circular in shape and comprises a major portion of a metal and resin-made portions provided on axially opposed sides of the major portion. More specifically, center plate 4 is a cylindrical member of which thickness (viz., axial length) is shorter than the diameter thereof.

As is seen in the drawing, center plate 4 is formed with two cylindrical through bores 4c and 4d through which the above-mentioned drive and driven shafts 6 and 7 pass respectively. Furthermore, center plate 4 has on its axially opposed portions projected portions that are substantially the same in shape, as will become apparent from the following.

That is, as is seen from FIGS. 2, 3 and 4, center plate 4 is integrally formed at axially opposed portions thereof with respective cylindrical projections 4a and 4e. A diameter of cylindrical projection 4e (4a) is slightly smaller than that of gear receiving recess 3a of front case 3, so that cylindrical projection 4a is intimately fitted in gear receiving recess 3a. Welding is used for tightly coupling center plate 4 and front case 3.

By the coupling between center plate 4 and front case 3, there is defined a first pump chamber 30 therebetween.

As is seen from FIGS. 2, 3 and 4, on an axially plus side portion of cylindrical projection 4a, there are provided both an annular projection 4b that is concentric with cylindrical through bore 4c and another annular projection 4h that is concentric with another cylindrical through bore 4d. As will be explained hereinafter, the two annular projections 4b and 4h are constructed of a resin.

As is seen from FIG. 2, the two annular projections 4b and 4h are in contact with axially minus side surfaces of first drive and driven gears 8 and 10 respectively.

As is seen from FIGS. 2 and 4, like in the above, center plate 4 is further formed at an axially minus side portion thereof with a cylindrical projection 4e. A diameter of cylindrical projection 4e is slightly smaller than that of gear receiving recess 5a of rear case 5, so that cylindrical projection 4e is intimately fitted in rear receiving recess 5a. For tightly coupling center plate 4 and rear case 5, welding is used.

By the coupling between center plate 4 and rear case 5, there is defined a second pump chamber 31 therebetween.

As is seen from FIGS. 2 and 4, at an axially minus side portion of cylindrical projection 4e, there are provided both an annular projection 4b′ that is concentric with cylindrical through bore 4c and another annular projection 4h′ that is concentric with another cylindrical through bore 4d. As will be explained hereinafter, the two annular projections 4b′ and 4h′ are constructed of a resin.

Actually, the two annular projections 4b′ and 4h′ are integrally connected through a bridge portion (no numeral) thereby to constitute a glasses like shape. Like this, the above-mentioned annular projections 4b and 4h are integrally connected through a bridge portion.

As is seen from FIG. 2, the two annular projections 4b′ and 4h′ are in contact with axially plus side surfaces of second drive and driven gears 9 and 11 respectively.

As is seen from FIG. 2, cylindrical through bore 4c of center plate 4 is formed with a larger cylindrical recess 4g that extends toward second drive gear 9. Within larger cylindrical recess 4g, there are tightly installed a shaft seal member 19 and a holder 21, as shown. Another cylindrical through bore 4d of center plate 4 is also formed with a larger cylindrical recess 4g′ that extends toward second driven gear 11. Within larger cylindrical recess 4g′, there are tightly installed a shaft seal member 20 and a holder 22.

As is seen from FIG. 4, the two annular projections 4b and 4h are integrally connected by a bridge portion and respectively have curved seal surfaces 4X and 4Y that are in oiltight contact with curved seal surfaces 27 and 28 provided by seal block 14 of first side plate 12. The other two annular projections 4b′ and 4h′ are integrally connected by a bridge portion (no numeral) and respectively have curved seal surfaces 4X′ and 4Y′ that are in oiltight contact with curved seal surfaces 28 and 27 provided by seal block 15 of second side plate 13.

It is to be noted that as will be understood from FIGS. 2 and 4, the four annular projections 4b, 4h, 4b′ and 4h′ are constructed of a resin of which friction coefficient is smaller than that of first drive and driven gears 8 and 10 and second drive and driven gears 9 and 11 which are made of a metal.

The resin is a so-called engineering resin which is for example, ABS (acrylonitrile butadiene styrene), PC (polycarbonates), PA (polyamides), PBT (polybutylene telephthalate), PET (polyethylene telephthalate), Polyimides, etc.

As is mentioned hereinabove, to the curved seal surfaces 27 and 28 (or 28 and 27), there slidably contact tops of teeth of drive and driven gears 8, 9, 10 and 11 under operation of pump device 1A.

As is seen from FIG. 2, center plate 4 is tightly disposed between front and rear cases 3 and 4, and thus, center plate 4 is not movable.

In the following, construction of first and second side plates 12 and 13 will be described in detail with reference to FIGS. 2, 3, 5, 6 and 7.

It is to be noted that first and second side plates 12 and 13 are the same in construction. This means that these two side plates 12 and 13 are usable in common.

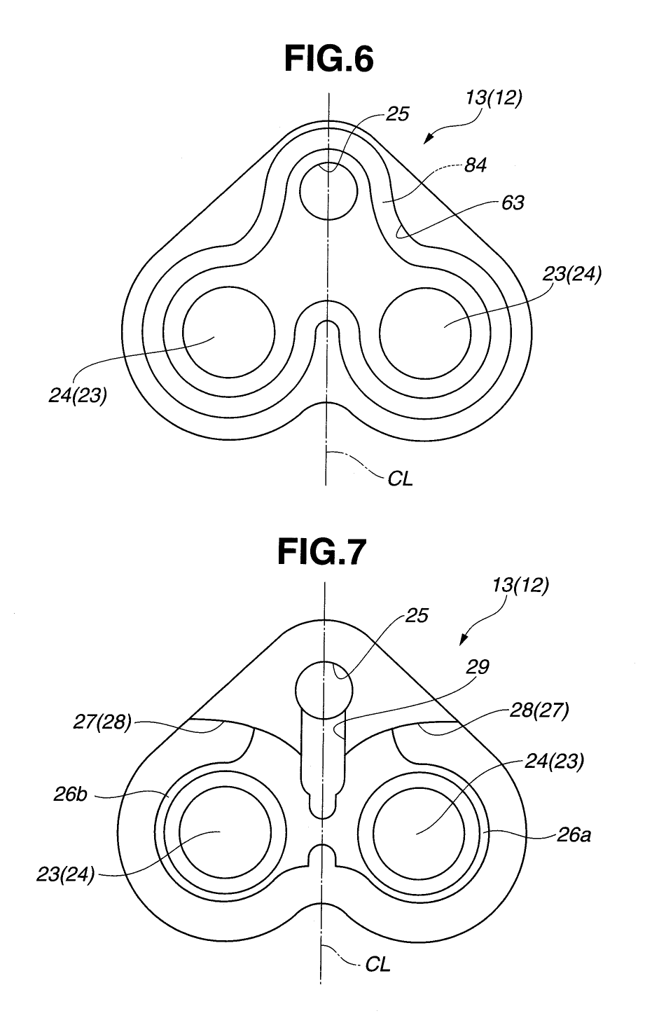

FIG. 5 is a perspective view of first or second side plate 12 or 13, FIG. 6 is a back view of first or second side plate 12 or 13, and FIG. 7 is a front view of first or second side plate 12 or 13.

That is, the back view of side plate 12 or 13 of FIG. 6 is a view taken from the position of front or rear case 3 or 5, and the front view of side plate 12 or 13 of FIG. 7 is a view taken from the position of center plate 4.

First and second side plates 12 and 13 are constructed of a resin, and as is seen from FIGS. 5 to 7, first and second side plates 12 and 13 have each an axisymmetrical shape with respect to an imaginary plane that passes along a center line “CL” of side plate shown in FIG. 5.

The resin for first and second side plates 12 and 13 has a friction coefficient that is smaller than that of first drive and driven gears 8 and 10 and second drive and driven gears 9 and 11 that are made of a metal.

It is to be noted that as will be understood from FIG. 2, first side plate 12 is a movable member that is axially movable but slightly in accordance with a hydraulic pressure exerted in first pump chamber 30. Also second side plate 13 is axially and slightly movable in accordance with a hydraulic pressure exerted in second pump chamber 31. The reason of the movement of first and second side plates 12 and 13 will be apparent hereinafter.

Referring back to FIG. 5, first side plate 12 is formed with two through bores 23 and 24 through which drive and driven shafts 6 and 7 pass respectively (see FIG. 2). As is seen from FIG. 5, first side plate 12 is formed with an intake bore 25 at a portion of the imaginary center line “CL” that passes between the two through bores 23 and 24.

As is seen from FIGS. 2 and 5, first side plate 12 is formed with two annular projections 26a and 26b that are integrally connected through a bridge portion (no numeral). These annular projections 26a and 26b are concentric with through bores 23 and 24 respectively, as shown.

As is seen from FIG. 2, upon assembly, two annular projections 26a and 26b are in contact with axially outside surfaces of first drive and driven gears 8 and 10 respectively.

It is to be noted that each annular projection 26a or 26b has a width of about 0.6 mm at a major rounded portion thereof that surrounds about ⅔ of through bore 23 or 24.

As is seen from FIG. 6 that shows a back view of first side plate 12, the plate 12 is formed on its back side surface with a complicatedly curved groove 63 that encloses the three bores 23, 24 and 25 as shown.

As is seen from FIG. 2, into the complicatedly curved groove 63, there is press-fitted a seal member 84, so that upon assembly, seal member 84 is operatively compressed between first side plate 12 and the bottom wall of gear receiving recess 3a of front case 3.

With provision of the seal member 84, a lower pressure area provided at a radially inside of seal member 84 and a higher pressure area provided at a radially outside of seal member 84 are oiltightly isolated from each other. This is important for the axial movement of first side plate 12.

As is seen from FIG. 5, seal block 14 is formed on an axially minus side portion of first side plate 12 and has the intake bore 25 formed therethrough. Seal block 14 comprises curved seal surfaces 27 and 28 that are curbed to partially surround tops of teeth of first drive and driven gears 8 and 10 (see FIGS. 2 and 3) respectively.

More specifically, curved seal surfaces 27 and 28 of seal block 14 of first side plate 12 are in oiltight contact with curved seal surfaces 4Y′ and 4X′ of the above-mentioned center plate 4. With this oiltight connection, there is defined the first pump chamber 30 (see FIG. 2).

Furthermore, under operation of pump device 1A, tops of teeth of drive and driven gears 8 and 10 slidably contact to the curved seal surfaces 27 and 28 for carrying out pumping of brake fluid.

As is seen in FIG. 5, between curved seal surfaces 27 and 28, there is formed an intake groove 29 that is merged with intake bore 25, as shown.

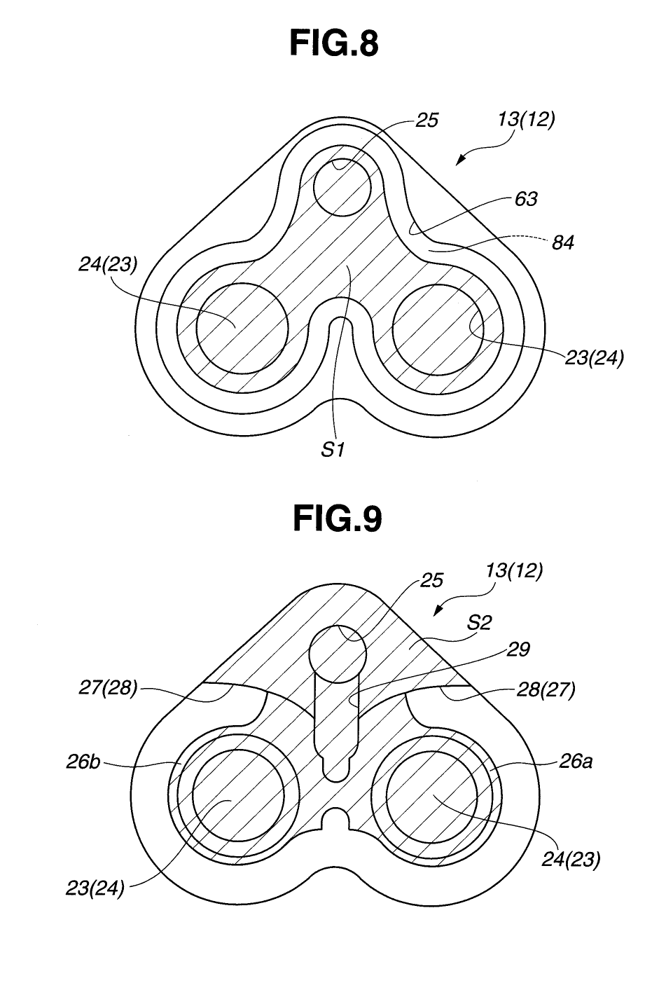

FIG. 8 shows a zone S1 (viz., the zone illustrated by diagonal lines) of an axially plus side surface of first side plate 12 where a lower pressure is exerted, and FIG. 9 shows a zone S2 (viz., the zone illustrated by diagonal lines) of an axially minus side surface of first side plate 12 where a lower pressure is exerted.

In the first embodiment of the present invention, the area of zone S1 is smaller than that of zone S2. With this difference in area between zone S1 and zone S2, advantageous movement of first side plate 12 (and second side plate 13) is carried out, as will become apparent hereinafter.

Although, in the above, detailed explanation is directed to only first side plate 12, second side plate 13 has substantially the same construction and arrangement as those of first side plate 12.

That is, as is shown in FIG. 2, second side plate 13 is put between each of second drive and driven gears 9 and 11 and a bottom wall of gear receiving recesses 5a of rear case 5. As shown in this drawing, annular projections 26b and 26a are in contact with axially minus side surfaces of second drive and driven gears 9 and 11 respectively.

In the following, advantageous operation of pump device 1A of the first embodiment will be described with the aid of the drawings.

Due to provision of first and second side plates 12 and 13 and center plate 4 that are assembled in the above-mentioned manner, higher and lower pressure areas are produced in pump device 1A, which are isolated from each other. Accordingly, undesired pressure leakage from higher pressure side to lower pressure side is suppressed while keeping a satisfied volumetric efficiency of pump device 1A.

As is seen in FIG. 2, in pump device 1A of the first embodiment, sealing in an axial direction is effected by the fixed center plate 4 and the axially movable first and second side plates 12 and 13.

As is described hereinabove, in pump device 1A, the area of zone S1 of the back side surface of each of first and second side plates 12 and 13 where lower pressure is exerted is smaller than the area of zone S2 of the front side surface of each of first and second side plates 12 and 13.

Accordingly, when pump device 1A starts to operate, there is produced a pressure difference between opposed side surfaces of each of first and side plates 12 and 13. With such pressure difference, first side plate 12 is biased toward first drive and driven gears 8 and 10 and second side plate 13 is biased toward second drive and driven gears 9 and 11. The reason of this biasing will be much apparent from the following description.

The force for biasing side plates 12 and 13 toward the gears 8, 10, 9 and 11 depends on a difference in area between the lower pressure zone S1 of back side surface of side plate 12 or 13 and the lower pressure zone S2 of front side surface of side plate 12 or 13. In other words, the force of biasing side plates 12 and 13 toward the gears 8, 10, 9 and 11 depends on a difference in area between the higher pressure zone of the back side surface of side plate 12 or 13 and the higher pressure zone of the front side surface of side plate 12 or 13.

That is, the area of the higher pressure zone on the back side surface of side plate 12 or 13 is larger than that of the higher pressure zone of the front side surface of side plate 12 or 13, and thus, the pressure on the back side surface of side plate 12 or 13 is larger than that on the front side surface of side plate 12 or 13. Thus, side plate 12 or 13 is biased toward center plate 4.

Actually, the side plate 12 or 13 is forced to stop at a position where a pressure balance is kept between the front and back side surfaces of side plate 12 or 13. That is, the difference between the two pressures decides the force with which side plates 12 and 13 are biased toward center plate 4. The pressure balance is so determined as to bias side plate 12 or 13 toward center plate 4 with a suitable force.

As is easily understood from FIG. 2, if a suitable biasing force is not applied to side plate 12 or 13 in a direction toward center plate 4, annular projections 26a and 26b of side plate 12 or 13 fail to effect a satisfied oiltight contact against side surfaces of gears 8, 10, 9 and 11. In this case, pump device 1A can not exhibit a satisfied pumping effect due to a fluid leakage.

The pressure balance depends on a ratio (or section ratio) between the area of higher pressure zone and that of lower pressure zone which are provided on an axial seal surface of side plate 12 or 13.

Strictly speaking, however, through bores 23 and 24, intake bore 25 and intake groove 29 of side plate 12 or 13 are areas which show the lowest pressure, and thus, such areas form a zone where the pressure of the brake oil from an external area of side plate 12 or 13 changes from a higher level to a lower level. It is to be noted that the above-mentioned section ratio corresponds to a hydraulic pressure distribution on an axial seal surface of side plate 12 or 13 indicating a condition of sealing and lubrication of that side plate 12 or 13.

Pump device used for the brake fluid pressure control system 32 (see FIG. 1) is made relatively small in size. Such small sized pump tends to have the following drawbacks due to its inherent construction.

That is, when it is intended to effect a clearance sealing against the axial seal surface of side plate 12 or 13 under a condition wherein the pressure of the brake oil changes from the higher level to the lower level is being carried out, it is difficult to sufficiently attain the clearance sealing due to an insufficient distance needed for the clearance sealing. In addition to this, due to the small-sized construction of pump device, the change of brake oil pressure from the higher level to the lower level is not smoothly carried out. Because of such reasons, stable lubrication to parts of pump device is not obtained and thus rotational resistance of drive and driven gears 8, 10, 9 and 11 against the side plate 12 or 13 is highly changed. Due to high change of the rotational resistance, satisfied volumetric efficiency of pump device has not been obtained.

For eliminating the above-mentioned drawbacks, pump device 1A of the present invention employs the following features.

In pump device 1A of the invention, annular projections 26a and 26b of first side plate 12, annular projections 26b and 26a of second side plate 13 and annular projections 4b, 4h, 4b′ and 4h′ of center plate 4 have a friction coefficient that is smaller than that of first drive and driven gears 8 and 19 and second drive and driven gears 9 and 11 which are made of a metal. For achieving this feature, all of annular projections 26a, 26b, 26b, 26a, 4b, 4h, 4b′ and 4h′ that are in contact with side surfaces of the corresponding gears 8, 9, 10 and 11 are constructed of a resin.

With this feature, the four gears 8, 9, 10 and 11 are applied with a less sliding resistance from annular projections 26a, 26b, 26b, 26a, 4b, 4h, 4b′ and 4h′ under operation of pump device 1A. Thus, even if the mechanical sealing is positively made to pump device 1A, mechanical efficiency of pump device 1A can be maintained.

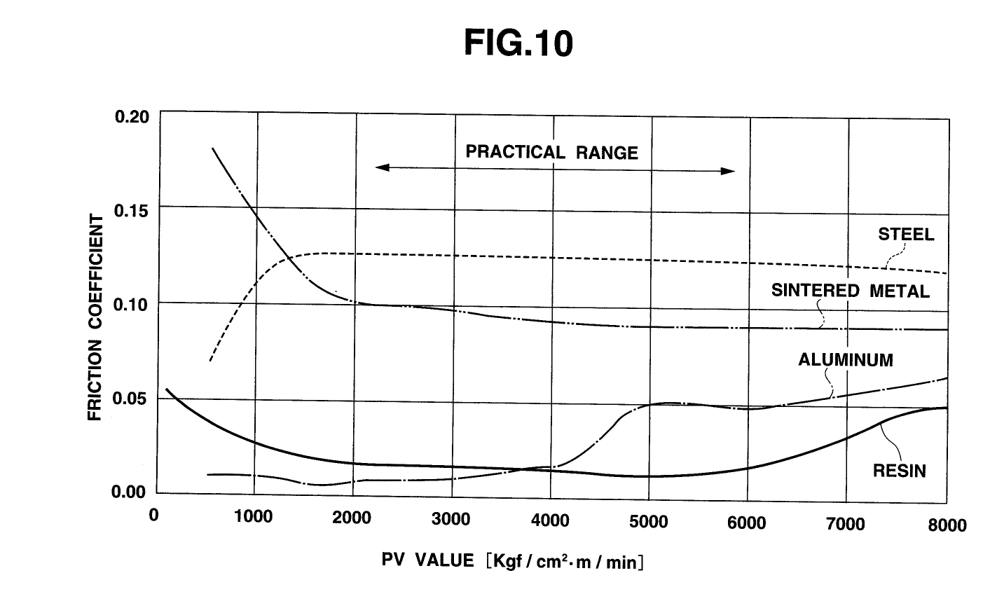

FIG. 10 is a graph depicting friction coefficients of four materials (viz., resin, aluminum, sintered metal and steel) for side plates 12 and 13 with respect to PV value.

In the graph of FIG. 10, the vertical axis (or y-axis) indicates a friction coefficient and the horizontal axis (or x-axis) indicates a product “PV” (Kgf/cm2·m/min) of the pressure “P” (Kgf/cm²) with which a selected material is pressed against the side surface of gear 8, 9, 10 or 11 and the speed “V” (m/min) at which the gear 8, 9, 10 or 11 rotates while sliding on the selected material. For ease of description, the product will be referred to PV value.

In the graph, the range from about 2000 in PV value to about 6000 in PV value is a practical range.

As is seen from the graph, within the practical range of PV value, the resin shows substantially the lowest friction coefficient.

This means that if the resin is used as a material of the axial seal surface of side plate 12 or 13, smoothed bearing is carried out against the gears 8, 9, 10 and 11 of metal without producing undesired heat. That is, due to the advantageous nature of the resin, long term usage of side plates 12 and 13 is expected.

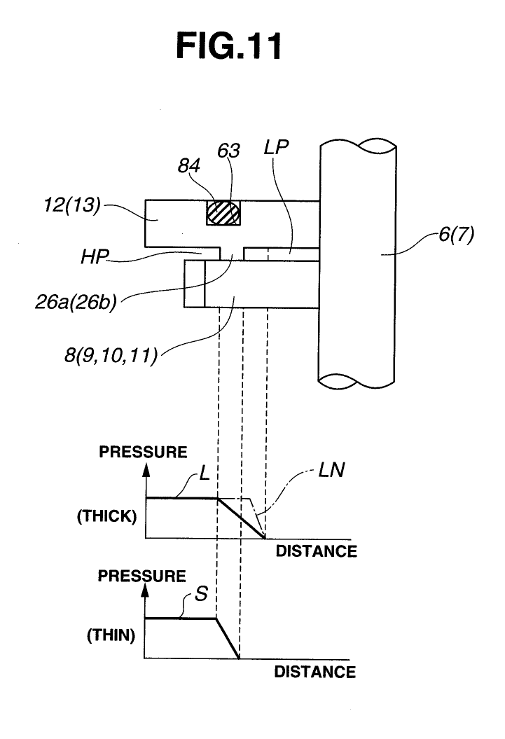

FIG. 11 is an illustration depicting the state of a transition of fluid pressure (viz., brake oil pressure) in a case wherein the width of annular projection 26a or 26b formed on side plate 12 or 13 is large or small.

Theoretically, it is desirable that at a top surface of annular projection 26a or 26b, the fluid pressure gradually and straightly reduces as a contact point of the top surface moves from an outer position exposed to the higher pressure part “HP” toward an inner position exposed to the lower pressure part “LP” as is indicated by the solid lines “L” and “S”.

However, due to some reasons, it tends to occur that such smoothed reduction is not carried out as is indicated by the phantom line “LN”. It has been revealed that such undesired pressure reduction manner tends to occur frequently when the width of the top surface of annular projection 26a or 26b is large.

Hitherto, in case of obtaining assured sealing by the top surface of the annular projection 26a or 26b, increasing the width of the top surface has been a common method.

While, in the present invention, reduction in width of the top surface of annular projection 26a or 26b is positively adopted. That is, by reducing the width, the pressure applied to the side surfaces of gear 8, 9, 10 or 11 from annular projection 26a or 26b per unit area increases, which improves the sealing ability of annular projection 26a or 26b against the side surfaces of gear 8, 9, 10 or 11.

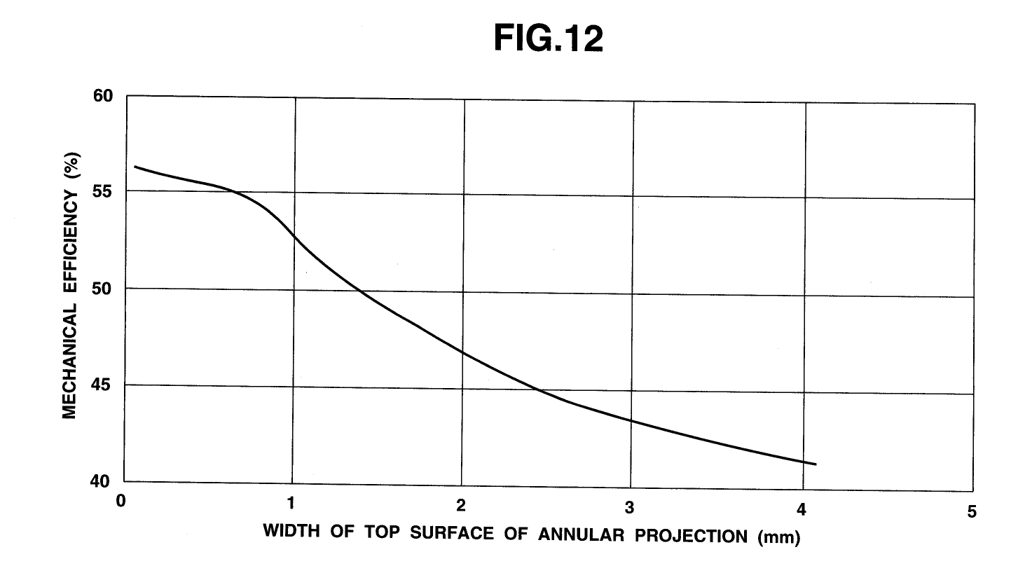

FIG. 12 is a graph depicting a relation between the width of the top surface of annular projection 26a or 26b of side plate 12 or 13 and a mechanical efficiency. As is seen from this graph, when the width of the top surface of annular projection 26a is about 0.6 mm, the mechanical efficiency shows the first large inflection point. With this, in pump device 1A of the first embodiment, the width of the top surface annular projections 26a and 26b is set to 0.6 mm.

In the following, advantages of pump device 1A of the first embodiment will be itemized.

(1) As is described hereinabove, a pump device 1A of the first embodiment comprises a first drive gear 8 mounted on a drive shaft 6, a first driven gear 10 meshed with the first drive gear 8 to be driven, a first side plate 12 arranged at a front side of the first drive and driven gears 8 and 10 and having a first side sealing portion (or contact surface) that is in contact with one side surface of each of the first drive and driven gears 8 and 10, a friction coefficient of the first side sealing portion being smaller than that of the first drive and driven gears, a second drive gear 9 mounted on the drive shaft 6, a second driven gear 11 meshed with the second drive gear 9 to be driven, a second side plate 13 arranged at a rear side of the second drive and driven gears 9 and 11 and having a second side sealing portion (or contact surface) that is in contact with one side surface of each of the second drive and driven gears 9 and 11, a friction coefficient of the second side sealing portion being smaller than that of the second drive and driven gears, a center plate 4 arranged between a unit of the first drive and driven gears 8 and 10 and another unit of the second drive and driven gears 10 and 11, the center plate 4 having at one side surface thereof one side sealing portion that is in contact with the other side surface of each of the first drive and driven gears 8 and 10 and at the other side surface thereof the other side sealing portion that is in contact with the other side surface of each of the second drive and driven gears 9 and 11, a friction coefficient of the one side sealing portion of the center plate 4 being smaller than that of the first drive and driven gears 8 and 10 and a friction coefficient of the other side sealing portion of the center plate 4 being smaller than that of the second drive and driven gears 9 and 11, a seal block 14 incorporated with center plate 4 and having curved seal surfaces 27 and 28 shaped to slidably contact tops of teeth of first drive and driven gears 8 and 10 respectively, a seal block 15 incorporated with center plate 4 and having curved seal surfaces 28 and 27 shaped to slidably contact tops of teeth of second drive and driven gears 9 and 10 respectively, a first pump chamber 30 for a first pump unit PP that is defined by center plate 4, first side plate 12, seal block 14 and first drive and driven gears 8 and 10, and a second pump chamber 31 for a second pump unit PS that is defined by center plate 4, second side plate 13, seal block 15 and second drive and driven gears 9 and 11, wherein when a master cylinder M/C produces a pressurized brake fluid due to depression of a brake pedal by a driver, each of the first and second pump units PP and PS takes in the pressurized brake fluid and feeds the pressurized brake fluid to selected wheel cylinders W/C through selected pressure ON/OFF valves 42FL, 42FR, 42RL and 42RR. More specifically, under operation of pump device 1A, tops of drive and driven gears 8, 9, 10 and 11 slidably contact the curved seal surfaces 27 and 28 (or 28 and 27).

Because of reduction in sliding resistance applied to first drive and driven gears 8 and 10 and second drive and driven gears 9 and 11, rotation of such gears is smoothly made and thus the mechanical efficiency of pump device 1A is increased even though the mechanical sealing is positively carried out.

(2) Because of the sealing contact of center plate 4, first side plate 12 and second side plate 13 against the drive and driven gears 8, 9, 10 and 11 in the above-mentioned manner, sealing is assuredly obtained therebetween.

(3) First and second side plates 12 and 13 are of a movable type that moves toward center plate 4 upon increase of hydraulic pressure in first or second pump chamber 30 or 31. Such axial movement induces increase in contact pressure applied to the side surface of gear 8, 9, 10 or 11 from annular projections 26a or 26b of first or second side plate 12 or 13, and thus, the sealing ability of annular projections 26a or 26b against the side surface of gear 8, 9, 10 or 11 is assured.

(4) Gears 8, 9, 10 and 11 are made of a metal and first and second side plates 12 and 13 including seal blocks 14 and 15 are made of a resin. Accordingly, even though gears 8, 9, 10 and 11 are forced to rotate at a high speed while frictionally contacting top surfaces of annular projections 26a and 26b of first and second side plates 12 and 13, substantially no heat is produced in annular projections 26a and 26b. Thus, undesired melting of the annular projections 26a and 26b is suppressed. The ease with which the resin can be shaped makes it particularly suitable for making a high precision sealing surface on the tops of annular projections 26a and 26b.

(5) Center plate 4 (see FIG. 4) comprises a center body made of a metal and two resin-made portions (4b, 4h, 4b′ and 4h′) that are provided at axially opposed sides of the center body, respectively. That is, the resin-made portions 4b, 4h, 4b′ and 4h′ are annular projections whose top surfaces are in contact with the other side surfaces of gears 8, 9, 10 and 11 (see FIG. 2). For the reasons mentioned hereinabove, resistance applied to gears 8, 9, 10 and 11 is small and thus, rotation of the gears is smoothly made.

(6) Due to similarity in material (viz., metal) between the center body of center plate 4 and front and rear cases 3 and 5, pump device 1A can be assembled without suffering drawbacks caused by thermal expansion (viz., difference in thermal expansion). Due to the nature of annular projections 4b, 4h,4b′ and 4h′ made of a resin, substantially no heat is produced in the projections 4b, 4h,4b′ and 4h′ even when the projections are in fictional contact with side surfaces of gears 8, 9, 10 and 11 that rotate at a high speed. Thus, like in side plates 12 and 13, undesired melting of the annular projections 4b, 4h,4b′ and 4h′ is suppressed.

(7) First side plate 12, second side plate 13 and the resin-made portions 4b, 4h, 4b′ and 4h′ of center plate 12 are made of the same resin. Thus, cost reduction is achieved.

(8) Since seal block 14 or 15 is integrally formed on first or second side plate 12 or 13, there is no need of preparing two moulds. This induces reduction in production cost.

### Second Embodiment

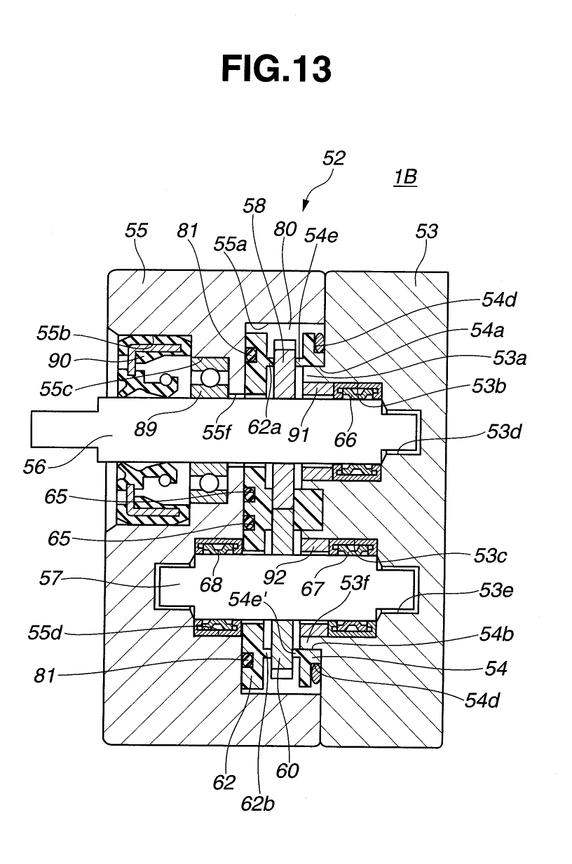

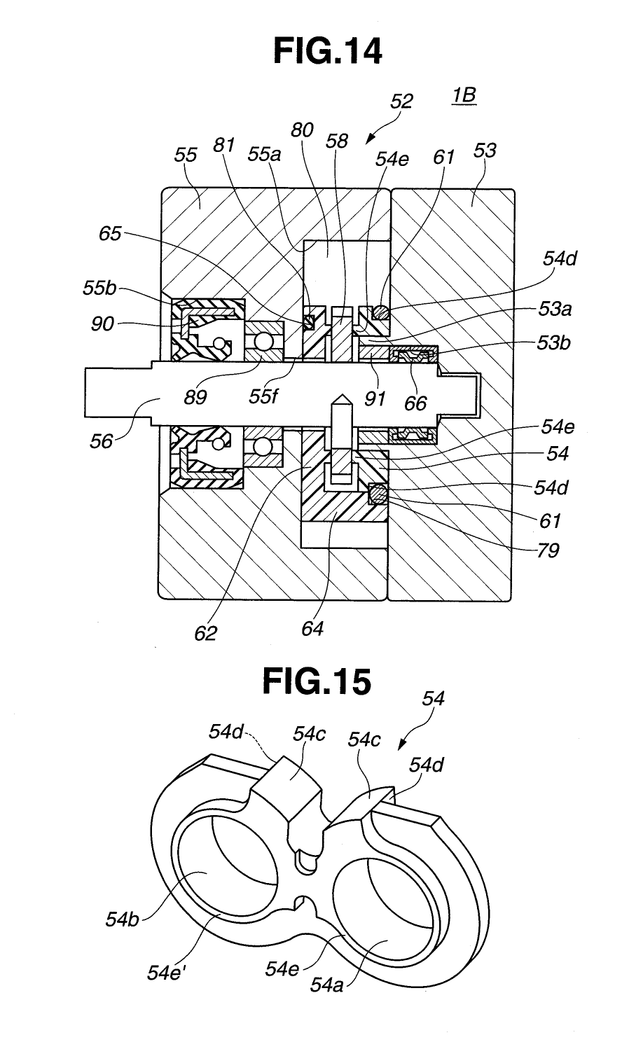

In the following, a pump device 1B of a second embodiment will be described in detail with the aid of the drawings, particularly FIGS. 13 and 14 that are axially sectioned views of pump device 1B.

Pump device 1A of the above-mentioned first embodiment is a tandem type external gear pump having two pump chambers 30 and 31.

However, pump device 1B of the second embodiment is a simple external gear pump having only one pump chamber.

As is seen from FIG. 13, pump device 1B has a pump case 52. Pump case 52 comprises a front case 53 and a rear case 55.

Like in the above-mentioned pump device 1A of the first embodiment, for ease of description, an axial direction of the assembled pump device 1B that is directed to front case 53 will be referred to “axially plus side or direction” and another axial direction of the pump device 1B that is directed to rear case 55 will be referred to “axially minus side or direction”.

Within pump case 52, there is rotatably installed a drive shaft 56 that is driven by an electric motor (not shown). To drive shaft 56, there is tightly mounted a drive gear 58 that thus rotates together with drive shaft 56.

Within pump case 52, there is further rotatably installed a driven shaft 57 that is arranged in parallel with drive shaft 56, as shown. To driven shaft 57, there is tightly mounted a driven gear 60 that thus rotates together with driven shaft 57.

As shown, drive gear 58 is engaged or meshed with driven gear 60.

At an axially plus side of drive and driven gears 58 and 60, there is arranged a first side plate 54, and at an axially minus side of drive and driven gears 58 and 60, there is arranged a second side plate 62. That is, the two flatly arranged gears 58 and 60 are put between first and second side plates 54 and 62.

First and second side plates 54 and 62 are each constructed of an engineering plastic such as, for example, ABS (acrylonitrile butadiene styrene), PC (polycarbonates), PA (polyamides), PBT (polybutylene telephthalate), PET (polyethylene telephthalate), Polyimides, etc.

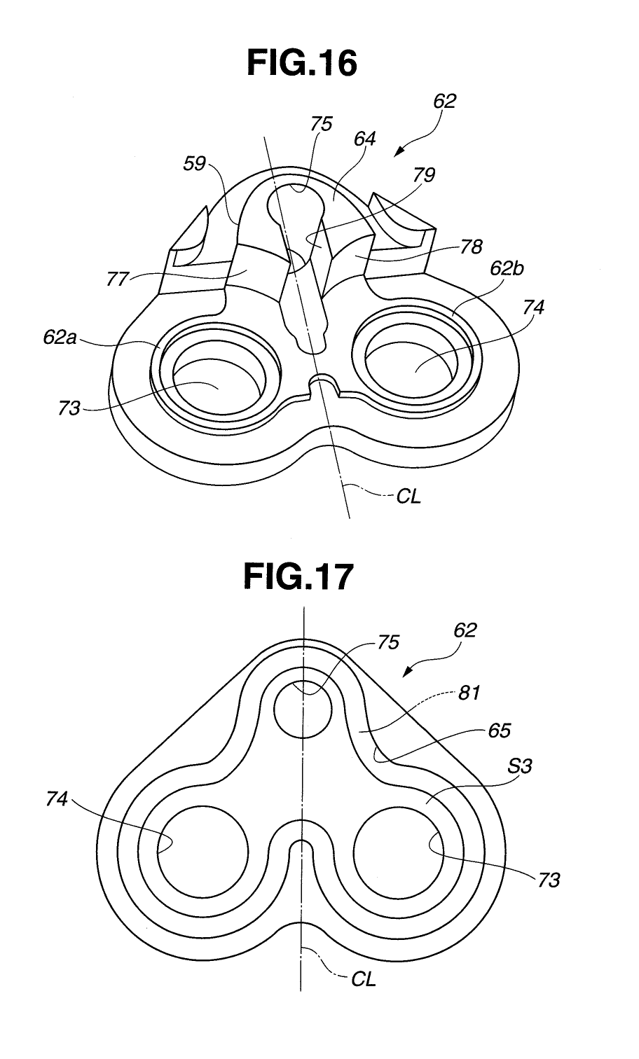

As is seen from FIGS. 14 and 16, second side plate 62 is integrally formed with a seal block 64 for providing curved seal surfaces 77 and 78 that face through bores 73 and 74 respectively as will become apparent hereinafter.

In the following, construction of front case 53 will be described in detail with the aid of FIGS. 13 and 14.

Front case 53 is made of a metal, and as is seen from FIG. 13, front case 53 is formed at its axially minus side with two annular projections 53a and 53f that project toward drive and driven gears 58 and 60 respectively.

Front case 53 is formed with two cylindrical bearing receiving bores 53b and 53c that extend from annular projections 53a and 53f in an axially plus direction respectively. The bores 53b and 53c are concentric with annular projections 53a and 53f respectively. Within bearing receiving bores 53b and 53c, there are press-fitted needle bearings 66 and 67 and holders 91 and 92, as shown.

As shown, from each bearing receiving bore 53b or 53c, there extends a drive shaft end receiving recess 53d or 53e in an axially plus direction. Within the recesses 53d and 53e, there are rotatably received respective ends (viz., right ends in FIG. 13) of drive and driven shafts 56 and 57, as shown.

In the following, construction of rear case 55 will be described in detail with the aid of FIGS. 13 and 14.

Rear case 55 is made of a metal and as is shown in FIG. 13, rear case 55 is formed with a cap-shaped gear receiving recess 55a that is opened to an axially plus side. Within gear receiving recess 55a, there are installed drive and driven gears 58 and 60 as shown.

Rear case 55 is secured to front case 53 by welding thereby to form the pump case 52. With this, there is defined a pump chamber 80 in gear receiving recess 55a.

From a bottom wall of gear receiving recess 55a, there extends a drive shaft passing bore 55f in an axially minus direction. At an axially minus end side of rear case 55, there is formed a seal member receiving recess 55b from which a bearing receiving recess 55c extends in an axially plus direction. These two recesses 55b and 55c are merged and concentric with drive shaft passing bore 55f.

Within bearing receiving recess 55c, there is press-fitted a ball bearing 89, and within seal member receiving recess 55b, there is operatively installed a seal member 90. As shown, an inner race of ball bearing 89 holds drive shaft 56 for smoothing rotation of drive shaft 56, and seal member 90 has lips that are in contact with a cylindrical outer surface of drive shaft 56 to achieve sealing therebetween.

As is seen from FIG. 13, from another position of the bottom wall of gear receiving recess 55a, there extends a bearing receiving recess 55d in an axially minus direction. Within bearing receiving recess 55d, there is press-fitted a needle bearing 68. From bearing receiving recess 55d, there extends a driven shaft end receiving recess 55e in an axially minus direction. Within recess 55e, there is rotatably received an end (viz., left end in FIG. 13) of driven shaft 57.

In the following, construction of first side plate 54 will be described in detail with the aid of FIGS. 13, 14 and 15.

As is seen from FIG. 15 that is a perspective view of first side plate 54, first side plate 54 is shaped like glasses and constructed of a resin.

As will become apparent as the description proceeds, first side plate 54 is formed with two annular projections 54e and 54e′ that are in contact with side surfaces of drive and driven gears 58 and 60 respectively. Like in the above-mentioned first embodiment, the resin of producing annular projections 54e and 54e′ has a friction coefficient which is smaller than that of drive and driven gears 58 and 60.

As is seen from FIG. 15, first side plate 54 is formed with two cylindrical bores 54a and 54b. Bores 54a and 54b are tightly disposed on the above-mentioned annular projections 53a and 53f of front case 53 respectively. With this disposition, first side plate 54 is tightly connected to front case 53. That is, first side plate 54 is not a movable plate.

As will be understood from FIGS. 13, 14 and 15, particularly FIG. 15, first side plate 54 is formed on its axially plus side surface with an endless round groove 54d that includes two annular parts that surround cylindrical bores 54a and 54b respectively.

As is seen from FIG. 15, annular projections 54e and 54e′ of first side plate 54 have at their upper portions (in the drawing) curved seal surfaces 54c and 54c that are in contact with after-mentioned curved seal surfaces of seal block 64 of second side plate 62.

In the following, construction of second side plate 62 will be described in detail with the aid of FIGS. 16 to 18.

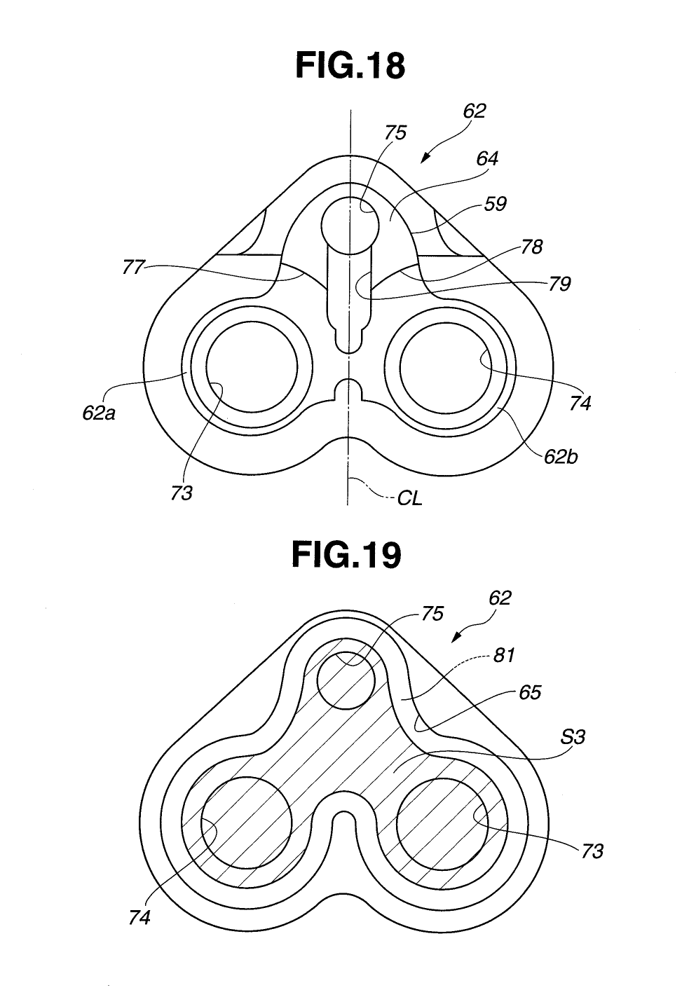

FIG. 16 is a perspective view of second side plate 62, FIG. 17 is a back view of second side plate 62 taken from the side of ball bearing 89 (see FIG. 13), FIG. 18 is a plan view of second side plate 62 taken from first side plate 54 (see FIG. 13).

Second side plate 62 is constructed of a resin and as is seen from FIGS. 14 and 16, second side plate 62 has an axisymmetrical shape with respect to an imaginary plane that passes along a center line “CL” of side plate in FIG. 16.

The resin for second side plate 62 has a friction coefficient that is smaller that that of drive and driven gears 58 and 60 that are made of a metal.

As will be understood from FIGS. 13 and 14, for the same reason as those as mentioned hereinabove, second side plate 62 is axially movable but slightly in accordance with a hydraulic pressure exerted in pump chamber 80.

Referring back to FIG. 16, second side plate 62 is formed with two through bores 73 and 74 through which drive and driven shafts 56 and 57 pass.

Second side plate 62 is integrally formed with seal block 64 for providing curved seal surfaces 77 and 78. Upon assembling, curved seal surfaces 54c and 54c of the above-mentioned first side plate 54 (see FIG. 15) are in contact with the curved seal surfaces 77 and 78 respectively for achieving an oiltight sealing therebetween.

Furthermore, the curved seal surfaces 77 and 78 slidably contact tops of teeth of drive and driven gears 58 and 60.

As shown in FIG. 16, second side plate 62 is formed with an intake bore 75 at a portion of the imaginary center line “CL” that passes between the two through bores 73 and 74.

As is seen from FIGS. 13 and 15, second side plate 62 is formed with annular projections 62a and 62b that are integrally connected through a bridge portion (no numeral). These annular projections 62a and 62b are concentric with through bores 73 and 74 respectively, as shown.

As is seen from FIG. 13, upon assembly, two annular projections 62a and 62b are in contact with axially minus surfaces of drive and driven gears 58 and 60 respectively.

It is to be noted that each annular projection 58 or 60 has a width of about 0.6 mm at a major rounded portion thereof that surrounds about ⅔ of through bore 73 or 74.

As is seen from FIG. 17 that shows a back view of second side plate 62, the plate 62 is formed on its back side surface with a complicatedly curved groove 65 that encloses the three bores 73, 74 and 75 as shown.

As is seen from FIGS. 13 and 14, into the complicatedly curved groove 65, there is press-fitted a seal member 81, so that upon assembly, seal member 81 is operatively compressed between second side plate 62 and the bottom wall of gear receiving recess 55a of rear case 55.

With provision of seal member 81, a lower pressure area provided at a radially inside of seal member 81 and a higher pressure area provided at a radially outside of seal member 81 are oiltightly isolated from each other. This is important for the axial movement of second side plate 62.

Between curved seal surfaces 77 and 78, there is formed an intake groove 79 that is merged with intake bore 75, as shown.

As is seen from FIG. 16, seal block 64 of second side plate 62 is formed with a curved seal groove 59 that is shaped to surround intake bore 75.

That is, as is seen from FIGS. 14, 15 and 16, upon assembly, the above-mentioned endless round groove 54d of first side plate 54 (see FIG. 15) and the intake groove 79 of second side plate 62 constitute a continuous groove into which a sealing member 61 is press-fitted. With this, sealing member 61, oiltight isolation at axially plus sides of first and second side plates 54 and 62 is achieved.

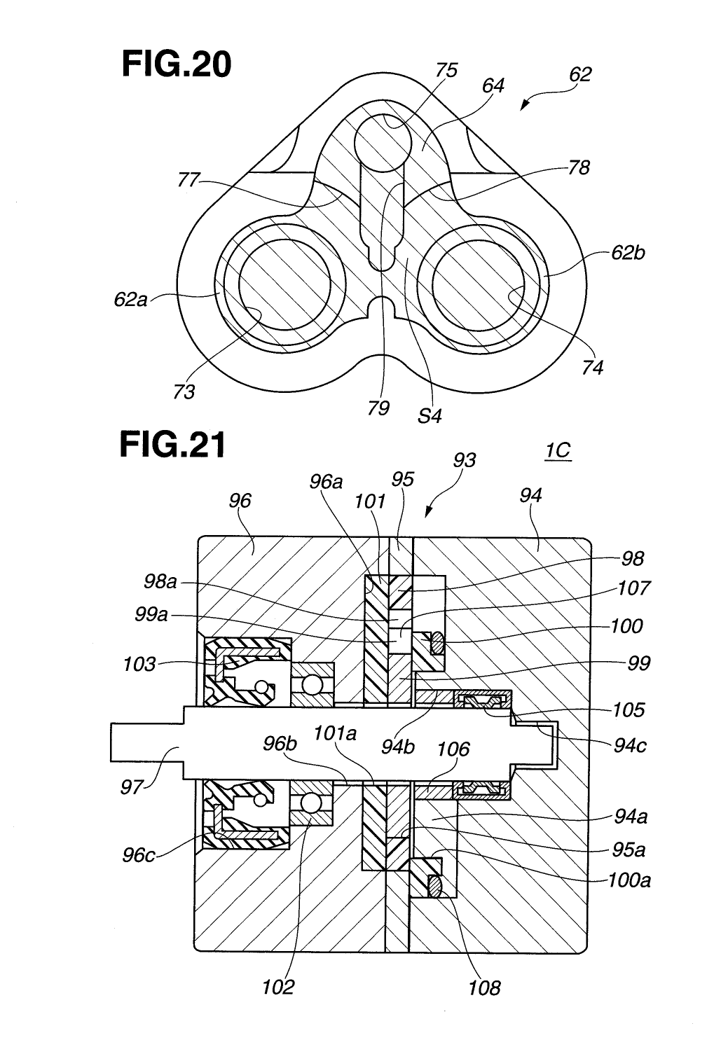

FIG. 19 shows a zone S3 (viz., the zone illustrated by diagonal lines) of an axially minus side surface of second side plate 62 where a lower pressure is exerted, and FIG. 20 shows a zone S4 (viz., the zone illustrated by diagonal lines) of an axially plus side surface of second side plate 62 where the lower pressure is exerted.

In the second embodiment of the present invention, the area of zone S1 is smaller than that of zone S4. With this difference in area between zone S3 and zone S4, advantageous movement of second side plate 62 is carried out as will become apparent as the description proceeds.

In the following, advantageous operation of pump device 1B of the second embodiment will be described with the aid of the drawings.

Hitherto, for achieving a satisfied sealing between side plate 54 or 62 and gear 58 or 60, it has been necessary to bias the side plate 62 toward gear 58 or 60 with a large force. However, in this case, smoothed rotation of gear 58 or 60 is not obtained due to larger sliding resistance applied to gear 58 or 60.

In view of the above, in the invention, the annular projections of first and second side plates 54 and 62 that are in contact with side surfaces of drive and driven gears 58 and 60 are constructed of a resin of which friction coefficient is smaller than that of the metal by which drive and driven gears 58 and 60 are made. With this, the sliding resistance applied to drive and driven gears 58 and 60 can be reduced and thus smoothed rotation of such gears 58 and 60 is obtained, which improves the mechanical efficiency of pump device 1B.

Since annular projections of first and second side plates 54 and 62 are constructed of a resin, substantially no heat is produced in the annular projections. Thus, undesired melting of the annular projections is suppressed. The ease with which the resin can be shaped makes it suitable for making a high precision sealing surface on the annular projections.

In the following, advantages of pump device 1B of the second embodiment will be itemized.

(1) As is described hereinabove, pump device 1B comprises a drive gear 58 mounted on a drive shaft 56, a driven gear 60 meshed with the drive gear 58 to be driven, a first side plate 54 constructed of a resin and having annular projections 54e and 54e′ that are in contact with one side surfaces of the drive and driven gears 58 and 60, the resin of the first side plate 54 having a friction coefficient that is relatively low, a second side plate 62 constructed of a resin and having annular projections 62a and 62b that are in contact with the other side surfaces of the drive and driven gears 58 and 60, the resin of the second side plate 62 having a friction coefficient that is relatively low, a seal block 64 constructed in cooperation with the second side plate 62 and having curved seal surfaces 77 and 78 shaped to oiltightly contact tops of teeth of the drive and driven gears 58 and 60 respectively, a pump chamber 80 that is defined by the first and second side plates 54 and 62 and the seal block 64, wherein when a master cylinder M/C produces a pressurized brake fluid due to depression of a brake pedal by a driver, a pump unit takes in the pressurized brake fluid and feeds the pressurized brake fluid to selected wheel cylinders W/C through selected pressure ON/OFF valves.

Because of reduction in sliding resistance applied to drive and driven gears 58 and 60, rotation of such gears is smoothly made and thus the mechanical efficiency of pump device 1B is increased even though the mechanical sealing is positively carried out.

(2) Because of the oiltight contact between the annular projections possessed by the first and second side plates 54 and 62 and the side surfaces of the drive and driven gears 58 and 60, a high sealing is obtained therebetween.

(3) Drive and driven gears 58 and 60 are constructed of metal, and first and second side plates 54 and 62 are constructed of a resin. Thus, for the reason as mentioned hereinabove, undesired melting of the annular projections of the side plates 54 and 60 is suppressed. The ease with which the resin can be shaped makes it particularly suitable for making a high precision sealing surface of the tops of annular projections.

(4) Seal block 64 is integrally formed on the second side plate 62, which induces reduction in a production cost.

(5) First side plate 54 is of a fixed type, and second side plate 62 is of a movable type. That is, in accordance with pressure increase in pump chamber 80, second side plate 62 is moved toward the gears 58 and 60 increasing contact pressure applied to the gears 58 and 60 from second side plate 62. With this, sealing between the annular projections 62a, 62b, 54e and 54e′ and drive and driven gears 58 and 60 is increased.

### Third Embodiment

In the following, a pump device 1C of a third embodiment will be described in detail with the aid of FIG. 21 that is an axially sectioned view of pump device 1C.

Pump devices 1A and 1B of the above-mentioned first and second embodiments are of an external gear type pump. However, pump device 1C of this third embodiment is of a trochoid type pump.

As is seen from FIG. 21, pump device 1C has a pump case 93. Pump case 93 comprises a front case 94, a center case 95 and a rear case 96.

Like in the above-mentioned pump devices 1A and 1B of the first and second embodiments, for ease of description, an axial direction of the assembled pump device 1C that is directed to front case 94 will be referred to “axially plus side or direction” and another axial direction of the pump device 1C that is directed to rear case 96 will be referred to “axially minus side or direction”.

Within pump case 93, there is rotatably installed a drive shaft 97 that is driven by an electric motor (not shown). To drive shaft 97, there is tightly mounted an inner rotor 99 that thus rotates together with drive shaft 97. Disposed around inner rotor 99 is an outer rotor 98. External teeth 99a of inner rotor 99 are operatively meshed with internal teeth 98a of outer rotor 98.

Due to the meshed engagement between teeth 99a and teeth 98a, there are defined a plurality of volume changeable spaces 107 therebetween. For defining such volume changeable spaces 107, in operation, each of teeth 98a of outer rotor 98 contacts each of teeth 99a of inner rotor 9 while functioning to seal each of teeth 99a of inner rotor 99.

It is to be noted that outer rotor 98 is constructed of a resin and inner rotor 99 is constructed of a metal (steel or the like). As has been mentioned hereinabove, the friction coefficient of the resin is lower than that of the metal.

At an axially plus side of inner rotor 99 and outer rotor 98, there is arranged a first side plate 100, and at an axially minus side of inner rotor 99 and outer rotor 98, there is arranged a second side plate 101. That is, the two flatly arranged rotors 99 and 98 are intimately but slidably put between first and second side plates 100 and 101.

First and second side plates 100 and 101 are each constructed of a resin (viz., engineering plastic).

In the following, construction of front case 94 will be described in detail with reference to FIG. 21.

Front case 94 is constructed of a metal and shaped cylindrical. As shown, front case 94 is formed with a cylindrical recess leaving a cylindrical projection 94a. This cylindrical projection 94a is eccentric relative the cylindrical outer surface of front case 94.

From cylindrical projection 94a, there extends in an axially plus direction a bearing receiving bore 94b. Within bearing receiving bore 94b, there are press-fitted a needle bearing 105 and a holder 106.

From bearing receiving bore 94b, there further extends in an axially plus direction a shaft end receiving recess 94c in which a right end (in FIG. 21) of drive shaft 97 is rotatably received.

In the following, construction of center case 95 will be described in detail.

Center case 95 is constructed of a resin and shaped like a disk. Center case 95 has therein a rotor receiving opening 95a for enclosing the mutually engaged inner and outer rotors 99 and 98. Rotor receiving opening 95a is eccentric relative to a cylindrical outer surface of center case 95.

In the following, construction of rear case 96 will be described in detail.

Rear case 96 is made of a metal and formed with a cylindrical recess 96a that faces in an axially plus direction. Within cylindrical recess 96a, there is intimately received the above-mentioned second side plate 101.

From a bottom wall of cylindrical recess 96a, there extends in an axially minus direction a drive shaft passing bore 96b through which drive shaft 97 rotatably passes, as shown. At an axially minus side portion of rear case 96, there is formed a seal receiving recess 96c and further a bearing receiving recess 96d. These two recesses 96c and 96d are concentric with drive shaft passing bore 96b. Within bearing receiving recess 96d, there is press-fitted a ball bearing 102 and within seal receiving recess 96c, there is press-fitted a seal member 103.

In the following, construction of first side plate 100 will be described in detail.

First side plate 100 is made of a resin and thus has a friction coefficient that is smaller than that of the metal by which inner rotor 99 is made. First side plate 100 is formed with a cylindrical opening 100a through which first side plate 100 is axially movably (but slightly) disposed on the above-mentioned cylindrical projection 94a of front case 94, as shown.

First side plate 100 is formed at an axially plus side surface thereof with a groove 100b into which a seal member 108 is press-fitted as shown.

Although now shown in the drawing (FIG. 21), first side plate 100 is so constructed as to move leftward in FIG. 21 when the hydraulic pressure in rotor receiving opening 95a of center case 95 is increased.

It is to be noted that such construction is easily provided when the above-mentioned axially moving function given to first and second side plates 12 and 13 of the first embodiment and second side plate 62 of the second embodiment is considered.

In the following, construction of second side plate 101 will be described in detail.

Second side plate 101 is made of a resin and thus has a friction coefficient that is smaller than that of the metal by which inner rotor 99 is made.

Second side plate 102 is shaped like a disk and formed with a circular opening 101a through which drive shaft 97 passes. As is seen from FIG. 21, circular opening 101a is eccentric relative to a cylindrical outer surface of second side plate 102. As shown, second side plate 102 is tightly received in cylindrical recess 96a of rear case 96. That is, second side plate 102 is not movable in an axial direction.

In the following, advantageous operation of pump device 1C of the third embodiment will be described with the aid of the drawing.

Hitherto, in case of obtaining assured sealing between first side plate 100 and each of inner and outer rotors 99 and 98 and between second side plate 101 and each rotor 99 or 98, biasing first side plate 100 toward second side plate 101 with a larger force has been a common method. However, in this case, sliding resistance applied to the inner and outer rotors 99 and 98 is inevitably increased thereby preventing inner rotor 99 from making a smoothed rotation. In this case, satisfied mechanical efficiency of pump device is not expected.

Accordingly, in pump device 1C of the third embodiment, first side plate 100, second side plate 101 and outer rotor 98 are made of a resin of which frictional coefficient is lower than that of to the metal by which inner rotor 99 is made. With this measure, the sliding resistance applied to inner rotor 99 can be reduced, and thus, the mechanical efficiency of pump device 1C can be increased.

Furthermore, because of usage of resin by which first side plate 100, second side plate 101 and outer rotor 98 are made, undesired melting of such parts caused by heat generated when the parts make relative rotation while contacting each other is suppressed. The ease with which the resin can be shaped makes it particularly suitable for making a high precision sealing surfaces of the first side plate 100, second side plate 101 and outer rotor 98.

In the following, advantages of pump device 1C of the third embodiment will be itemized.

(1) As is described hereinabove, pump device 1C comprises an inner rotor 99 tightly mounted on a drive shaft 97, a first side plate 100 arranged at an axially one side of the inner rotor 99 and slidably contacting one side surface of the inner rotor, the first side plate 100 being constructed of a resin of which frictional coefficient is lower than that of a metal by which the inner rotor 99 is made, a second side plate 101 arranged at the other axial side of the inner rotor 99 and slidably contacting the other side surface of the inner rotor, the second side plate 101 being constructed of a resin of which frictional coefficient is lower than that of the metal by which the inner rotor 99 is made, and an outer rotor 98 of which inner teeth 98a are meshed with external teeth 99a of the inner rotor 99 thereby to form a plurality of volume changeable spaces 107 for pumping a brake fluid, the inner teeth 98a of outer rotor 98 having a frictional coefficient that is smaller than that of inner teeth 99a of inner rotor 99.

With this arrangement, the sliding resistance applied to inner rotor 99 is reduced, and thus the mechanical efficiency of pump device 1C can be increased.

(2) First side plate 100 is a movable plate that moves toward inner rotor 99 when the hydraulic pressure in rotor receiving opening 95a of center case 95 is increased. With such movement, sealing between first side plate 100 and inner rotor 99 and sealing between second side plate 101 and inner rotor 99 are both assured.

(3) Inner rotor 99 is made of a metal, and first side plate 100, second side plate 101 and outer rotor 98 are made of a resin.

Accordingly, the undesired melting of such parts caused by heat generated when the parts make relative rotation while contacting each other is suppressed. The ease with which the resin can be shaped makes it particularly suitable for making a high precision sealing surfaces of the first side plate 100, second side plate 101 and outer rotor 98. This brings about reduction in production cost of pump device 1C.

(4) Inner rotor 99 makes a rotation relative to first side plate 100 while contacting the same, and inner rotor 99 makes a rotation relative to second side plate 101 while contacting the same. Accordingly, satisfied sealing is obtained between the mutually contacting parts.

(5) First side plate 100, second side plate 101 and outer rotor 98 can be made of a common resin. In this case, production cost of pump device 1C can be reduced.

(6) Outer rotor 98 is made of a resin and inner rotor 99 is made of a metal. Because the teeth of outer rotor 98 that contact the teeth of inner rotor 99 are constructed of the resin, the sliding resistance applied to inner rotor 99 can be reduced. Thus, mechanical efficiency of pump device 1C can be increased.

The entire contents of Japanese Patent Application 2011-065614 filed Mar. 24, 2011 are incorporated herein by reference.

Although the invention has been described above with reference to the embodiments of the invention, the invention is not limited to such embodiments as described above. Various modifications and variations of such embodiments may be carried out by those skilled in the art, in light of the above description.

What is claimed is:

1. A pump device comprising:
a drive gear driven by a drive shaft;
a first side plate arranged at an axial side of the drive gear and having a first contact surface that is in contact with a first side surface of the drive gear, a friction coefficient of the first contact surface being smaller than that of the first side surface of the drive gear;
a second side plate arranged at the other axial side of the drive gear and having a second contact surface that is in contact with a second side surface of the drive gear, a friction coefficient of the second contact surface being smaller than that of the second side surface of the drive gear; and
a seal member incorporated with the first and second side plates to constitute a pump chamber to pump an operation fluid from an inlet to an outlet, the seal member functioning to seal tops of teeth of the drive gear and having a friction coefficient that is smaller than that of the tops of the teeth.

2. A pump device as claimed in claim 1, in which the first side plate is of a movable type and moves toward the drive gear upon increase of hydraulic pressure in the pump chamber thereby to increase a contact pressure between the first contact surface and the first side surface, and in which the second side plate is of a fixed type.

3. A pump device as claimed in claim 2, in which the drive gear is constructed of a metal and the first side plate, the second side plate and the seal member are constructed of a resin.

4. A pump device as claimed in claim 3, in which the first side plate and the seal member are integrally molded.

5. A pump device as claimed in claim 4, in which the first contact surface of the first side plate and the first side surface of the drive gear are in sliding contact with each other and in which the second contact surface of the second side plate and the second side surface of the drive gear are in sliding contact with each other.

6. A pump device as claimed in claim 2, in which the first slide plate, the second slide plate and the seal member are constructed of a common resin.

7. A pump device as claimed in claim 1, in which the drive gear is an inner rotor of a trochoid pump and the seal member is an outer rotor of the trochoid pump.

8. A pump device comprising:
a drive gear driven by a drive shaft;
a driven gear meshed with the drive gear to rotate;
a first side plate arranged at one side of the drive and driven gears and having a first contact surface that is in contact with first side surfaces of the drive and driven gears, a friction coefficient of the first contact surface being smaller than that of the first side surfaces of the drive and driven gears;
a second side plate arranged at the other side of the drive and driven gears and having a second contact surface that is in contact with second side surfaces of the drive and driven gears, a friction coefficient of the second contact surface being smaller than that of the second side surfaces of the drive and driven gears; and
a seal member incorporated with the first and second side plates to constitute a pump chamber to pump an operation fluid from an inlet to an outlet, the seal member functioning to seal tops of teeth of the drive and driven gears and having a friction coefficient that is smaller than that of the tops of the teeth.

9. A pump device as claimed in claim 8, in which the first contact surface of the first side plate and each of the first side surfaces of the drive and driven gears are in sliding contact with each other and in which the second contact surface of the second side plate and each of the second side surfaces of the drive and driven bears are in sliding contact with each other.

10. A pump device as claimed in claim 9, in which the drive and driven gears are constructed of a metal and the first side plate, the second side plate and the seal member are constructed of a resin.

11. A pump device as claimed in claim 10, in which the first side plate and the seal member are integrally molded.

12. A pump device as claimed in claim 11, in which the first side plate is of a movable type and moves toward the drive and driven gears upon increase of hydraulic pressure in the pump chamber thereby to increase a contact pressure between the first contact surface and each of the first side surfaces, and in which the second side plate is of a fixed type.

13. A pump device for use in a brake fluid pressure control system, comprising:
a first drive gear driven by a drive shaft;
a first driven gear meshed with the first drive gear to rotate;
a first side plate arranged at one side of the pump device and having a first contact surface that is in contact with first side surfaces of the first drive and driven gears, a friction coefficient of the first contact surface being smaller than that of the first side surfaces of the first drive and driven gears;
a second drive gear driven by the drive shaft together with the first drive gear;
a second driven gear meshed with the second drive gear to rotate;
a second side plate arranged at the other side of the pump device and having a second contact surface that is in contact with second side surfaces of the second drive and driven gears, a friction coefficient of the second contact surface being smaller than that of the second side surfaces of the second drive and driven gears;
a center plate arranged between a unit of the first drive and driven gears and another unit of the second drive and driven gears, the center plate having a third contact surface that is in contact with third side surfaces of the first drive and driven gears and a fourth contact surface that is in contact with fourth side surfaces of the second drive and driven gears, a friction coefficient of the third contact surface being smaller than that of the third side surfaces and a friction coefficient of the fourth contact surface being smaller than that of the second drive and driven gears;
a first seal member incorporated with the first side plate and the center plate to constitute a first pump chamber to pump an operation fluid from an inlet to an outlet, the first seal member functioning to seal tops of first teeth of the first drive and driven gears and having a friction coefficient that is smaller than that of the tops of the firth teeth; and
a second seal member incorporated with the second side plate and the center plate to constitute a second pump chamber to pump the operation fluid from another inlet to another outlet, the second seal member functioning to seal tops of second teeth of the second drive and driven gears and having a friction coefficient that is smaller than that of the tops of the second teeth,
wherein upon brake operation by a driver, each of the first and second pump chambers takes in a brake fluid from a master cylinder and feeds the brake fluid to selected wheel cylinders of road wheels through selected pressure ON/OFF valves.

14. A pump device as claimed in claim 13, in which the third contact surface of the center plate and each of the third side surfaces of the first drive and driven gears are in sliding contact with each other, and in which the fourth contact surface of the center plate and each of the fourth side surfaces of the second drive and driven gears are in sliding contact with each other.

15. A pump device as claimed in claim 14, in which each of the first and second side plates are of a movable type and moves toward the center plate upon increase of hydraulic pressure in the first and second pump chambers thereby to increase a contact pressure between the third contact surface and each of the third side surfaces and a contact pressure between the fourth contact surface and each of the fourth side surfaces, and in which the center plate is of a fixed type.

16. A pump device as claimed in claim 15, in which the first drive and driven gears and the second drive and driven gears are made of a metal and in which the first side plate, the second side plate, the first seal member and the second seal member are made of a resin.

17. A pump device as claimed in claim 16, in which the center plate comprises a major portion made of a metal and resin-made portions that are mounted to opposed surfaces of the major portion respectively, the resin-made portions being in contact with side surfaces of the first drive and driven gears as well as side surfaces of the second drive and driven gears.

18. A pump device as claimed in claim 17, in which the first side plate, the second side plate, the first seal member and the second seal member are constructed of a common resin.

19. A pump device as claimed in claim 17, in which the first side plate and the first seal member are integrally molded.

20. A pump device as claimed in claim 17, in which the second side plate and the second seal member are integrally molded.
